(19) United States
(12) Patent Application Publication
(10) Pub. No.: US 2023/0311578 A1
(43) Pub. Date: Oct. 5, 2023

(54) TIRE WITH INTERLOCKING BAND TYPE 3D KERF

(71) Applicant: Hankook Tire & Technology Co., Ltd., Seongnam (KR)

(72) Inventors: Jae Hyuk SIM, Daejeon (KR); Su Bin CHOI, Daejeon (KR)

(21) Appl. No.: 18/128,168

(22) Filed: Mar. 29, 2023

(30) Foreign Application Priority Data
Mar. 29, 2022 (KR) 10-2022-0039210

(51) Int. Cl. B60C 11/12

(52) U.S. Cl. CPC B60C 11/1218; B60C 11/1281

(57) ABSTRACT

There is provided a technology for minimizing shape deformation of a block formed on a tire in a case of braking, driving, or the like of the tire. There is provided a tire with an interlocking band type 3D kerf according to the embodiment of the invention, including a kerf having a road holding part which is a space formed in the block by extending in a direction inward to the tire from a ground contact surface of the block that comes into contact with a road, a projection part which is a space in the block with both side wall surfaces that is formed by extending from the road holding part and at which a protrusion portion having a shape projecting from one side wall surface is formed, and a base part which is a space in the block that is formed by extending from the projection part.

### BACKGROUND OF THE INVENTION

### Field of the Invention

The present invention relates to a tire with an interlocking band type 3D kerf, and more specifically, to a technology for minimizing shape deformation of a block formed on a tire in a case of braking, driving, or the like of the tire.

### Description of the Related Art

A groove is formed to have a certain thickness in a block formed in a tread pattern of a general tire, and the groove is referred to as a sipe or a kerf. The corresponding kerf plays a role of forming an edge of the block on a snow-covered road (snow road), and the edge plays a role of breaking a snow layer and enhancing driving performance on the snow road.

The edge of the block is formed by a corner of a block facing the ground by bending deformation of a plurality of blocks when a tire is driven, and thus a method for improving wear performance by minimizing the deformation of the blocks and increasing a ground contact area needs to be provided.

Korean Pat. Registration No. 10-1631758 (Title of Invention: KERF STRUCTURE AND PNEUMATIC TIRE COMPRISING THE SAME) discloses a pneumatic tire comprising a tread, a side wall, and a bead part, wherein having kerfs formed at the tread blocks of a pneumatic tire in which a plurality of blocks and a plurality of grooves are formed, each of the kerfs having: surface opening kerf portions that are formed at a tread surface and form a repeated continuous shape enabling contiguous blocks divided by the kerfs to interlock with each other when the kerfs intermesh with each other; and vertical extending kerf portions that extend in a depth direction from the tread surface and form a shape enabling contiguous blocks divided in a vertical direction by the kerfs to interlock with each other when the kerfs intermesh with each other.

### CITATION LIST

### Patent Literature

Patent Literature 1: Korean Pat. Registration No. 10-1631758

### SUMMARY OF THE INVENTION

An object of the invention to solve the above-described problem is to minimize shape deformation of a block formed on a tire in a case of braking, driving, or the like of the tire.

Technical objects to be achieved by the invention are not limited to the technical object mentioned above, and the following description enables the other unmentioned technical objects to be clearly understood by a person of ordinary skill in the art to which the invention pertains.

According to a configuration of the invention to achieve the object described above, a tire having a block includes a kerf having a road holding part which is a space formed in the block by extending in a direction inward to the tire from a ground contact surface of the block that comes into contact with a road, a projection part which is a space in the block with both side wall surfaces that is formed by extending from the road holding part and at which a protrusion portion having a shape projecting from one side wall surface is formed, and a base part which is a space in the block that is formed by extending from the projection part. The protrusion portion is formed by a coupling or group of a plurality of protrusions.

According to an embodiment of the invention, the protrusion portion may have a central protrusion which is a protrusion formed at a central region of the projection part.

According to the embodiment of the invention, the protrusion portion may have side protrusions which are protrusions formed at both sides of the central protrusion, respectively.

According to the embodiment of the invention, the central protrusion and the side protrusions may be coupled to each other.

According to the embodiment of the invention, the central protrusion and the side protrusions may be separated from each other.

According to the embodiment of the invention, the central protrusion may be formed in plurality.

According to the embodiment of the invention, the central protrusion may have a bent portion.

According to the embodiment of the invention, regarding a cross section perpendicular to a length direction of the kerf, the central protrusion and the side protrusions may have a quadrangular cross section.

### BRIEF DESCRIPTION OF THE DRAWINGS

FIG. 1 is a side view of a block according to an embodiment of the invention;

FIGS. 2 to 4 are schematic views of protrusion portions according to respective embodiments of the invention;

FIG. 5 is a table indicating analysis result data of braking-directional strength of blocks according to the respective embodiments of the invention;

FIG. 6 is an image of a contact area of a kerf in sliding analysis according to an embodiment of the invention; and

FIG. 7 is a table indicating analysis result data of a ground contact surface of a block during driving according to an embodiment of the invention.

### DETAILED DESCRIPTION OF THE PREFERRED EMBODIMENTS

Hereinafter, the invention will be described with reference to the accompanying drawings. However, the invention can be realized as various different examples and thus is not limited to embodiments to be described here. Further, a part unrelated to the description is omitted from the drawings in order to clearly illustrate the invention, and similar reference signs are assigned to similar parts throughout this specification.

In the entire specification, when a certain part “is connected to (accesses, is in contact with, or is coupled to)” another part, this includes not only a case where the parts are “directly connected” to each other, but also a case where the parts are “indirectly connected” to each other with another member interposed therebetween. In addition, when a certain part “comprises” a certain configurational element, this means that another configurational element is not excluded but the configurational element can be further included, unless specifically described otherwise.

A term used in this specification is only used to describe a specific embodiment and is not intentionally used to limit the invention thereto. A singular form of a noun includes a meaning of the plural form of the noun, unless obviously implied otherwise in context. In this specification, a term such as “to comprise” or “to have” is construed to specify that a feature, a number, a step, an operation, a configurational element, a part, or a combination thereof described in the specification is present and not to exclude presence or a possibility of addition of one or more other features, numbers, steps, operations, configurational elements, parts, or combinations thereof in advance.

Hereinafter, the invention will be described in detail with reference to the accompanying drawings.

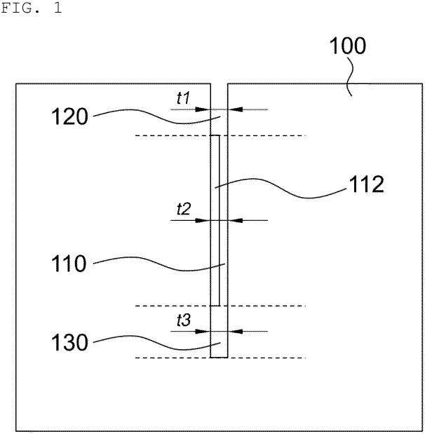

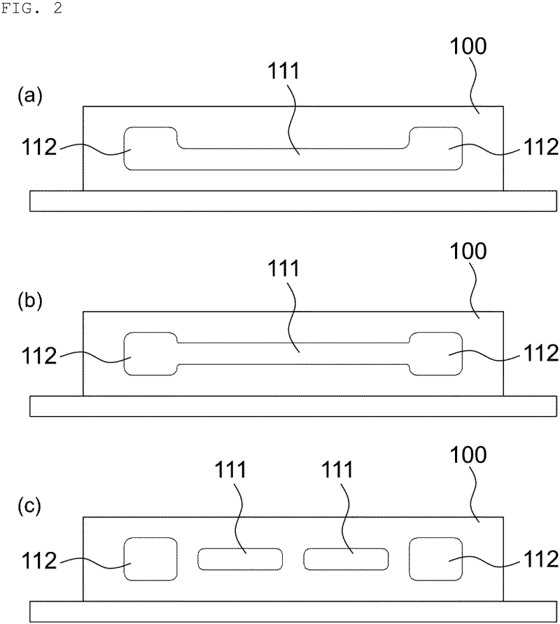

FIG. 1 is a side view of a block 100 according to an embodiment of the invention, and FIGS. 2 to 4 are schematic views of protrusion portions according to respective embodiments of the invention. Specifically, FIG. 1 is a side view of the block 100 of a seventh embodiment. In FIG. 1, a road holding part 120, a projection part 110, and a base part 130 are illustrated as respective regions divided by dotted lines.

As illustrated in FIGS. 1 to 4, a tire having the block 100 includes a kerf having the road holding part 120 which is a space formed in the block 100 by extending in a direction inward to the tire from a ground contact surface of the block 100 that comes into contact with a road, the projection part 110 which is a space in the block 100 with both side wall surfaces that is formed by extending from the road holding part 120 and at which a protrusion portion having a shape projecting from one side wall surface is formed, and the base part 130 which is a space in the block 100 that is formed by extending from the projection part 110.

Here, the protrusion portion can be formed by a coupling or group of a plurality of protrusions. The coupling of the plurality of protrusions is a method for forming the protrusion portion by coupling one protrusion to another protrusion together, and the group of the plurality of protrusions is a method for forming the protrusion portion by forming one protrusion and another protrusion in a contiguous manner in a state of being separated from each other. Hereinafter, the embodiments will be described.

(a) of FIG. 2 may illustrate a protrusion portion formed at a block 100 of a first embodiment, (b) of FIG. 2 may illustrate a protrusion portion formed at a block 100 of a second embodiment, and (c) of FIG. 2 may illustrate a protrusion portion formed at a block 100 of a third embodiment.

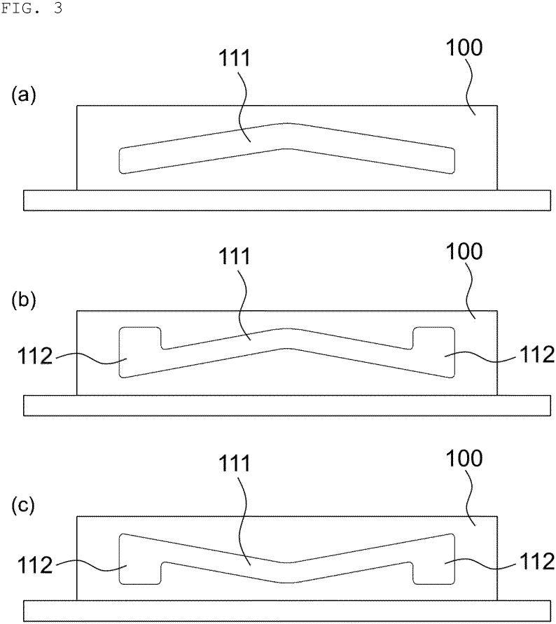

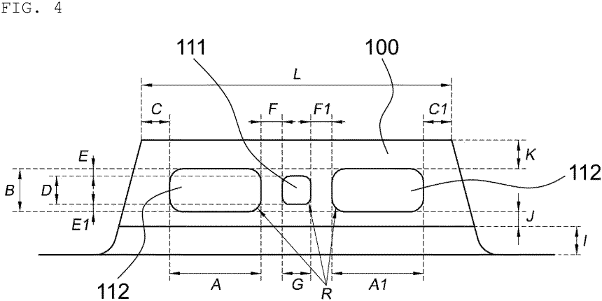

In addition, (a) of FIG. 3 can illustrate a protrusion portion formed at a block 100 of a fourth embodiment, (b) of FIG. 3 can illustrate a protrusion portion formed at a block 100 of a fifth embodiment, and (c) of FIG. 3 can illustrate a protrusion portion formed at a block 100 of a sixth embodiment. Further, FIG. 4 may illustrate a protrusion portion formed at the block 100 of the seventh embodiment.

As illustrated in FIGS. 1 to 4, the protrusion portion can have a central protrusion 111 which is a protrusion formed at a central region of the projection part 110. The central protrusion 111 can project from one side wall surface of the projection part 110 to have a thickness.

Here, the blocks 100 of the first to seventh embodiments can have the respective central protrusions 111. However, as illustrated by the block 100 of the fourth embodiment, the protrusion portion can be formed by a single central protrusion 111.

The protrusion portion can have side protrusions 112 which are protrusions formed at both sides of the central protrusion 111, respectively. Here, the central protrusion 111 and the side protrusions 112 can be coupled to each other, or the central protrusion 111 and the side protrusions 112 can be separated from each other. The central protrusion 111 and the side protrusions 112 can be separated from each other in a contiguous manner so as to form a group of protrusions, and thereby the protrusion portion can be formed.

The central protrusion 111 and the side protrusions 112 can be coupled to each other at the block 100 of the first embodiment, the block 100 of the second embodiment, the block 100 of the fifth embodiment, and the block 100 of the sixth embodiment. In addition, the central protrusion 111 and the side protrusions 112 can be separated from each other at the block 100 of the third embodiment and the block 100 of the seventh embodiment.

The central protrusion 111 can be formed in plurality. Specifically, as illustrated by the block 100 of the third embodiment, two or more central protrusions 111 can be formed at a central region of one side wall surface of the projection part 110.

In the embodiments of the invention, when the plurality of central protrusions 111 is formed, the central protrusions 111 and the side protrusions 112 are described to be divided and separated from each other; however, the invention is not limited thereto, and central protrusions 111 formed to be contiguous to respective side protrusions 112 can be coupled to the respective side protrusions 112.

The central protrusion 111 can have a bent portion. The bent portion can be formed at at least one portion at the central protrusion 111, and the central protrusion 111 can have a bent shape at a central portion thereof.

Further, as illustrated by the block 100 of the fourth embodiment and the block 100 of the fifth embodiment, a corner bent at the bent portion of the central protrusion 111 can be formed toward a ground contact surface of the block 100. Alternatively, as illustrated by the block 100 of the sixth embodiment, a corner bent at the bent portion of the central protrusion 111 can be formed toward an inner side of the tire.

Regarding a cross section perpendicular to a length direction of the kerf, the central protrusion 111 and the side protrusions 112 can have a quadrangular cross section. In other words, all of the protrusions can be formed into a column or bar shape having a quadrangular cross section, and the central protrusion 111 can have a bent bar shape having a quadrangular cross section.

As described above, the cross-sectional shape of the protrusions is described in the embodiments of the invention; however, the cross-section shape of the protrusions is not limited thereto, and the protrusions can be formed into other shapes.

Hereinafter, with reference to FIGS. 2 to 4, the protrusion portions provided at the blocks 100 of the respective embodiments will be described in detail.

As illustrated in (a) of FIG. 2, the block 100 of the first embodiment can have the side protrusions 112 which extend from one side wall surface of the projection part 110 in a projecting direction so as to have a quadrangular column shape at locations contiguous to both the side edges of the one side wall surface of the projection part 110.

Further, the central protrusion 111 can be formed between the side protrusions 112 at both sides by extending in the projecting direction from the one side wall surface of the projection part 110. The central protrusion 111 can be formed into a bar shape with a quadrangular cross section.

Here, one end of the central protrusion 111 can be coupled to a lower portion of one side protrusion 112, and the other end of the central protrusion 111 can be coupled to a lower portion of the other side protrusion 112. Further, the corners of the protrusions can be rounded to have a curved surface.

As illustrated in (b) of FIG. 2, the block 100 of the second embodiment can have the side protrusions 112 which extend from one side wall surface of the projection part 110 in a projecting direction so as to have a quadrangular column shape at locations contiguous to both the side edges of the one side wall surface of the projection part 110.

Further, the central protrusion 111 can be formed between the side protrusions 112 at both sides by extending in the projecting direction from the one side wall surface of the projection part 110. The central protrusion 111 can be formed into a bar shape with a quadrangular cross section.

Here, one end of the central protrusion 111 can be coupled to a central portion of one side protrusion 112, and the other end of the central protrusion 111 can be coupled to a central portion of the other side protrusion 112. Further, the corners of the protrusions can be rounded to have a curved surface.

As illustrated in (c) of FIG. 2, the block 100 of the third embodiment can have the side protrusions 112 which extend from one side wall surface of the projection part 110 in a projecting direction so as to have a quadrangular column shape at locations contiguous to both the side edges of the one side wall surface of the projection part 110.

Further, the central protrusion 111 can be formed between the side protrusions 112 at both sides by extending in the projecting direction from the one side wall surface of the projection part 110. The central protrusion 111 can be formed into a bar shape with a quadrangular cross section.

Here, the central protrusion 111 can be formed in two, and each central protrusions 111 can be formed to be separated from each other. The central protrusions 111 can also be formed to be separated from the side protrusions 112. The left central protrusion 111 can be formed contiguously to the left side protrusion 112, and the right central protrusion 111 can be formed contiguously to the right side protrusion 112, based on (c) of FIG. 2. Further, the corners of the protrusions can be rounded to have a curved surface.

As illustrated in (a) of FIG. 3, the block 100 of the fourth embodiment can have the central protrusion 111 formed by extending in the projecting direction from the one side wall surface of the projection part 110. The central protrusion 111 can be formed into a bar shape with a quadrangular cross section, and a bent portion can be formed at a center of the central protrusion 111.

Further, the bent portion can be formed to have a corner bent toward a ground contact surface of the block 100 at the bent portion of the central protrusion 111. The block 100 of the fourth embodiment can have the protrusion portion formed by a single central protrusion 111. The corners of the protrusion can be rounded to have a curved surface.

As illustrated in (b) of FIG. 3, the block 100 of the fifth embodiment can have the side protrusions 112 which extend from one side wall surface of the projection part 110 in a projecting direction so as to have a quadrangular column shape at locations contiguous to both the side edges of the one side wall surface of the projection part 110.

Further, the central protrusion 111 can be formed between the side protrusions 112 at both sides by extending in the projecting direction from the one side wall surface of the projection part 110. The central protrusion 111 can be formed into a bar shape with a quadrangular cross section.

In addition, a bent portion can be formed at a center of the central protrusion 111. The bent portion can be formed to have a corner bent toward a ground contact surface of the block 100 at the bent portion of the central protrusion 111. The above-described shape enables the central protrusion 111 and the side protrusions 112 to have respective inclined surfaces.

Here, one end of the central protrusion 111 can be coupled to a lower portion of one side protrusion 112, and the other end of the central protrusion 111 can be coupled to a lower portion of the other side protrusion 112. Further, the corners of the protrusions can be rounded to have a curved surface.

As illustrated in (c) of FIG. 3, the block 100 of the sixth embodiment can have the side protrusions 112 which extend from one side wall surface of the projection part 110 in a projecting direction so as to have a quadrangular column shape at locations contiguous to both the side edges of the one side wall surface of the projection part 110.

Further, the central protrusion 111 can be formed between the side protrusions 112 at both sides by extending in the projecting direction from the one side wall surface of the projection part 110. The central protrusion 111 can be formed into a bar shape with a quadrangular cross section.

In addition, a bent portion can be formed at a center of the central protrusion 111. The bent portion can be formed to have a corner bent toward an inner side of the tire at the bent portion of the central protrusion 111. The above-described shape enables the central protrusion 111 and the side protrusions 112 to have respective inclined surfaces.

Here, one end of the central protrusion 111 can be coupled to an upper portion of one side protrusion 112, and the other end of the central protrusion 111 can be coupled to an upper portion of the other side protrusion 112. Further, the corners of the protrusions can be rounded to have a curved surface.

The blocks 100 of the first to sixth embodiments can include the respective kerfs having a depth of 3 mm to 10 mm. In addition, the road holding part 120 can have a thickness t1 of 0.3 mm to 1.0 mm. In addition, the base part 130 can have a thickness t3 of 0.3 mm to 1.0 mm. Further, the projection part 110 can be formed to have a thickness t2 which is variable in a range of 0.2 mm to 0.4 mm due to the forming of the protrusions.

As illustrated in FIG. 4, the block 100 of the seventh embodiment can have the side protrusions 112 which extend from one side wall surface of the projection part 110 in a projecting direction so as to have a quadrangular column shape at locations contiguous to both the side edges of the one side wall surface of the projection part 110.

Further, the central protrusion 111 can be formed between the side protrusions 112 at both sides by extending in the projecting direction from the one side wall surface of the projection part 110. The central protrusion 111 can have a quadrangular column shape.

The central protrusion 111 can be formed to be separated from side protrusions 112 at both sides. Further, the corners of the protrusions can be rounded to have a curved surface. Specifically, the protrusions can have the radius of curvature R of 0.3 mm to 1.0 mm.

In addition, one to five protrusions can be formed depending on a length L of the kerf, and the central protrusion 111 can have a height D of 1 mm or longer to a length corresponding to 70% of a total depth of the kerf. Further, the side protrusions 112 can have a height B of 1 mm or longer to a length corresponding to 70% of the total depth of the kerf.

Lengths A and A1 of the side protrusions 112 and a length G of the central protrusion 111 can be equal to or different from each other and can vary with the length L of the kerf. Distances C and C1 between outer side surfaces of the block 100 and the side protrusions 112 can vary and can be set to 1 mm or longer with consideration for manufacturability.

A vertical distance E between an upper end of the central protrusion 111 and an upper end of the side protrusions 112 can be set to 0 to 2 mm, and a vertical distance E1 between a lower end of the central protrusion 111 and a lower end of the side protrusions 112 can be set to 0 to 2 mm.

Distances F and F1 between the central protrusion 111 and the side protrusions 112 can vary, and both the distances F and F1 between the central protrusion 111 and the side protrusions 112 can be set to 1 mm or longer with consideration for manufacturability.

A distance I between a bottom surface of the kerf, which is a surface corresponding to the ground contact surface of the block 100 and is coupled to a tread surface, and a bottom surface of the block 100 can be set to 0 to 5 mm with consideration for a groove depth.

A depth K of the road holding part 120 can vary and can be set to 1 mm or longer with consideration for manufacturability, and a depth J of the base part 130 can vary and can be set to 1 mm or longer with consideration for manufacturability.

As described above, the protrusion portion is formed at the kerf, and the protrusion formed at the one side wall surface of the kerf comes into contact with the other side wall surface of the kerf so as to inhibit excessive deformation of the block 100 even when the block 100 is deformed due to the space of the kerf during driving of the tire, and thereby the deformation of the block 100 can be minimized. Hence, the strength of the block 100 can have an increase in strength.

Further, numerical values set as described above can improve manufacturing performance of the block 100 and simultaneously improve deformation resistance efficiency of the block 100.

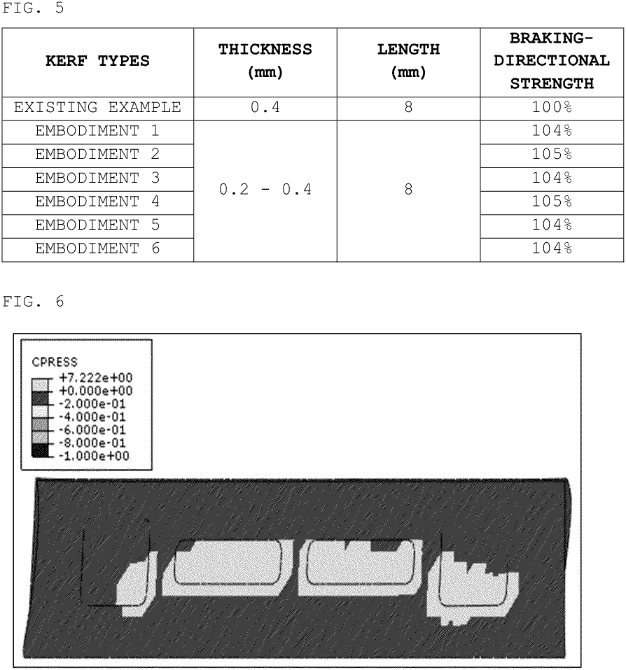

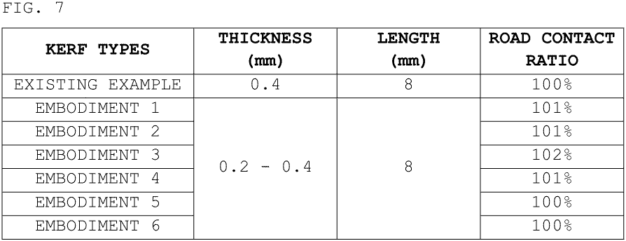

FIG. 5 is a table indicating analysis result data of braking-directional strength of blocks 100 according to the respective embodiments of the invention. Further, FIG. 6 is an image of a contact area of a kerf in sliding analysis according to an embodiment of the invention.

Specifically, FIG. 5 provides data of the strength of the blocks 100 of the respective embodiments which is measured during braking of the tire by conducting finite element analysis of the blocks 100 of the respective embodiments. Here, an existing block 100 which is a block 100 with an existing kerf type can have a shape of the block 100 of the first embodiment from which the protrusion portion is removed. The others are identical.

FIG. 6 illustrates results of the block 100 of the third embodiment, and a gray region (protrusion-formed region) is a contact portion during braking of a tire.

As illustrated in FIGS. 5 and 6, contact of the protrusion portion is performed in the kerf of the block 100 during the braking of the tire, and thus the deformation of the block 100 can be minimized such that the strength of the block 100 can be improved. Specifically, the blocks 100 of the respective embodiments can be confirmed to have a strength increase effect by 4% or 5% higher than that of the existing block.

FIG. 7 is a table indicating analysis result data of a ground contact surface of a block 100 during driving according to an embodiment of the invention. Specifically, FIG. 7 is a table of data of ground contact ratios of the blocks 100 of the respective embodiments with a road surface during the driving of the tire which is measured by performing the finite element analysis of the blocks 100 of the respective embodiments.

As illustrated in FIG. 7, compared to the existing block 100, the blocks 100 of some embodiments can be confirmed to have an increase of 1% or 2% in ground contact ratio with the road surface, which is higher than that of the existing block. Hence, when a tire with the kerf of the invention is used, it can be confirmed that the protrusion portion minimizes the deformation of the block 100, and thus the ground contact ratio of the block 100 with the road surface can be improved.

In this case, a ground contact area of the tire when the tire is worn is increased, and thus the tire can be advantageous in wear performance.

The description of the present invention described above is provided as an example, and a person of ordinary skill in the art to which the present invention pertains can understand that it is possible to easily modify the present invention to another embodiment without changing the technical idea or the essential feature of the present invention. Therefore, the embodiments described above are to be construed as exemplified examples in every aspect and not as examples limiting the invention. For example, the configurational elements described in a singular forma may be realized in a distributed manner. Similarly, the configurational elements described in distributed manner may be realized in a combined manner.

The scope of the invention is represented by the claims to be described below, and the meaning and the scope of the claims and every modified or altered examples derived from the equivalent concept of the claims is to be construed to be included in the scope of the present invention.

According to configurations described above, the invention is effective in that the protrusion portion is formed at the kerf, and the protrusion formed at the one side wall surface of the kerf comes into contact with the other side wall surface of the kerf so as to inhibit excessive deformation of the block even when the block is deformed due to a space of the kerf during driving of the tire, and thereby deformation of the block can be minimized.

Further, the invention is effective in that the minimized deformation of the block can result in an increase in strength of the block.

Effects of the invention are to be construed not to be limited to the above-described effects but to include any effect that can be derived from the configurations of the invention described in the detailed description of the preferred embodiments and claims of the invention.

While the present invention has been described with respect to the specific embodiments, it will be apparent to those skilled in the art that various changes and modifications may be made without departing from the spirit and scope of the invention as defined in the following claims.

What is claimed is:

1. A tire, having a block, with an interlocking band type 3D kerf, comprising:
a kerf having a road holding part which is a space formed in the block by extending in a direction inward to the tire from a ground contact surface of the block that comes into contact with a road, a projection part which is a space in the block with both side wall surfaces that is formed by extending from the road holding part and at which a protrusion portion having a shape projecting from one side wall surface is formed, and a base part which is a space in the block that is formed by extending from the projection part,
wherein the protrusion portion is formed by a coupling or group of a plurality of protrusions.

2. The tire with an interlocking band type 3D kerf according to claim 1,
wherein the protrusion portion has a central protrusion which is a protrusion formed at a central region of the projection part.

3. The tire with an interlocking band type 3D kerf according to claim 2,
wherein the protrusion portion has side protrusions which are protrusions formed at both sides of the central protrusion, respectively.

4. The tire with an interlocking band type 3D kerf according to claim 3,
wherein the central protrusion and the side protrusions are coupled to each other.

5. The tire with an interlocking band type 3D kerf according to claim 4,
wherein the central protrusion has a bent portion.

6. The tire with an interlocking band type 3D kerf according to claim 3,
wherein the central protrusion and the side protrusions are separated from each other.

7. The tire with an interlocking band type 3D kerf according to claim 6,
wherein the central protrusion formed in plurality.

8. The tire with an interlocking band type 3D kerf according to claim 3,
wherein, a cross section perpendicular to a length direction of the kerf, the central protrusion and the side protrusions have a quadrangular cross section.

9. The tire with an interlocking band type 3D kerf according to claim 2,
wherein the central protrusion has a bent portion.
